(19) United States
(12) Patent Application Publication
(10) Pub. No.: US 2017/0316458 A1
(43) Pub. Date: Nov. 2, 2017

(54) POLLING SYSTEM SUPPORTING ADVERTISER-DEFINED CUSTOM TARGETING

(71) Applicant: Ervin Peretz, Redmond, WA (US)

(72) Inventor: Ervin Peretz, Redmond, WA (US)

(21) Appl. No.: 15/140,320

(22) Filed: Apr. 27, 2016

(51) Int. Cl. G06Q 30/02

(52) U.S. Cl. CPC G06Q 30/0255; G06Q 30/0277; G06Q 30/0257; G06Q 30/0269

(57) ABSTRACT

A facility providing systems and methods for targeting advertisements based on a polling system is disclosed. The facility provides techniques for interleaving advertisements within a stream of “split queries.” The ads are themselves split queries and are inserted sparsely into the split stream. An ad campaign may include “branch” nodes, with decision logic over the targeting variables representative of a program, complete with dynamic variables and flow control (branching logic). Via this paradigm, the ad campaign can direct highly specific users toward specialized content and offers. In addition to their value as ad impressions, splits may have associated with them custom advertiser-defined targeting variables and actions for how user responses update those variables. These variables may then be used as targeting variables.

### BACKGROUND

Advertising on mobile devices such as mobile phones has not succeeded to a significant degree, primarily due to the lack of available screen real estate for presenting ads alongside users' desired content. There have been several attempts to inject advertising into mobile entertainment experiences by using the time dimension—that is, as “interstitials.” This is analogous to the traditional commercial break on television, but shortened for the web experience. Ad breaks and “interstitials” can be a jarring and unwelcome experience because they are distinct from the user's intended content and they represent a loss of control for the user. Furthermore, online ad campaigns can be targeted to specific users via a growing set of demographic, geographic, and even “psychographic” variables, all defined by the advertising system. However, as detailed as these system-defined variables are, they cannot address advertiser-specific targeting needs that the ad system designers did not preconceive. In summary, the online advertising industry has not properly addressed computing experiences on small mobile form factors and generally does not have sufficient flexibility for advertiser-specific targeting variables.

### BRIEF DESCRIPTION OF THE DRAWINGS

FIG. 1 is a block diagram illustrating some of the components that may be incorporated in at least some of the computer systems and other devices on which the disclosed technology operates and with which the disclosed technology interacts.

FIG. 2 is a page diagram illustrating several entertainment splits in accordance with some embodiments of the disclosed technology.

FIG. 3 is a page diagram illustrating a gamification split in accordance with some embodiments of the disclosed technology.

FIG. 4 is a page diagram illustrating advertising splits in accordance with some embodiments of the disclosed technology.

FIG. 5 is a page diagram illustrating a graphical user interface for authoring split queries in accordance with some embodiments of the disclosed technology.

FIG. 6 is a page diagram illustrating a user interface for authoring decision logic for a branch node in the action logic.

FIG. 7 is a block diagram illustrating a user interface for composing split queries and branch nodes into a split advertisement campaign in accordance with some embodiments of the disclosed technology.

FIG. 8 is a flow diagram illustrating the processing of a split presentation component in accordance with some embodiments of the disclosed technology.

### DETAILED DESCRIPTION

A facility providing systems and methods for targeting advertisements based on a polling system and interleaving advertisements within a stream of “split queries” or “split polls” is disclosed. A “split query” or “split poll” (or “split”) represents a question presented to a user with two or more potential responses. A user can respond to the split by selecting (e.g., clicking on) one of the associated potential responses. In some cases, the ads are themselves split queries (or adverting splits), and can be inserted sparsely into the split stream. A campaign, such as an advertising campaign or a campaign for collecting information from users (e.g., a polling campaign), may include “branch” nodes, with decision logic over the targeting variables representative of a program, complete with dynamic variables and flow control (branching logic) and “non-branch” nodes, which direct a user to a subsequent split within a corresponding ad campaign and can be used, for example, to collect information from users in response to corresponding split queries. In some embodiments, this concept can be extended to decision logic with more than two paths, such as a “switch” node with two or more outcomes (e.g., “true,” “false,” and “unknown”) or a set of enumerated values (e.g., if A then . . . , else if B then . . . , else if C then . . . , else . . . ). The switch node could naturally be represented graphically, similarly to a branch node. Via this paradigm, the ad campaign can direct highly specific users toward specialized content and offers. In some embodiments, the facility is implemented as a web application or a mobile application for small form factors such as mobile phones and/or for tiny form factors such as wearable devices. The facility provides attractiveness and framework for interleaving commercially oriented split queries within a stream of split queries. These commercial queries can be a form of brand advertising. In addition to their value as ad impressions, these advertising splits may have associated with them custom advertiser-defined targeting variables and actions for how user responses update those variables.

In some embodiments, these variables may then be used as targeting variables. For example, a car vendor may wish to target users who have not purchased a car in the past 5 years; a print vendor may wish to target users who prefer black-and-white photography over color; a rowboat vendor may wish to target users who live on the waterfront; and a coffee vendor may wish to target coffee drinkers who are not already his/her customers. These exemplify highly advertiser-specific and nuanced targetings that are not possible with traditional online advertising platforms. Accordingly, an advertiser may establish appropriate customer variables and corresponding custom splits to obtain relevant information (e.g., a split asking a user what type of photography he or she prefers with two potential responses: “black-and-white” and “color”). In this manner, the facility allows an advertiser's campaign to generate splits specific to his or her information needs. This targeting paradigm is highly customizable and advertiser-specific. It is more powerful than the demographic and geographic targeting of other online advertising systems, which have targeting variables predefined by the system. Thus, the facility provides an improved technique for building advertising campaigns and appropriately targeting those advertising campaigns. In addition, the infrastructure for authoring the polls or queries allows for systematized data collection by an advertiser or advertising service, and the definition and development of custom targeting variables that are specific to the advertiser's product and marketing goals.

In some embodiments, the facility provides an entertaining experience on wearable form factors, many of which have few successful applications due to the limitations of the screen size. For example, the disclosed system can present splits (e.g., a question or two images) on a smart wristwatch and receive responses to the split via user interaction with the watch. Similarly, the facility allows for: viable spatially integrated advertising on mobile platforms, where advertising in general has not been successful due to the limited screen size; advertising that is thematically integrated into the entertaining content; the creation of custom targeting variables by the advertiser; capturing custom demographic and psychographic data about users that cannot be anticipated by a traditional advertising platform; and branching logic over those (and other) variables, making the advertising campaign effectively a program with dynamic variables and flow control (e.g., branching logic). In some embodiments, the facility integrates the processes for creation, delivery, and redemption of digital coupons and offers to targeted users.

In some embodiments, the facility presents users with questions, possibly accompanied by contextual images. In some embodiments, there are two possible answers to each question, represented by two buttons or two images. Each such query is called a “split.” The user responds to a split query by, for example, clicking or touching one button or image associated with different responses to the query. The system then presents the user with the next split query. The entertainment value of the split queries is in the form of the content of the splits themselves—which may be quirky, humorous, or touch on Zeitgeist in news and popular culture. There may also be gamification in the form of trivia queries, possibly including the winning of points, credits, prizes, etc.

In some embodiments, the entertainment-oriented split queries dominate the user's polling experience. These split queries are generated through a combination of curation and user-generated content. The stream of split queries presented to the user is selected by the serving system to be most relevant and entertaining to the user, based on known data about the user and his/her responses to previous split queries. For example, if a user responds “No” to a split asking the user if the user enjoys sports, then the system may avoid presenting sports-related splits to the user. Furthermore, split queries can be replicated and shared via social networks and on social websites such as Facebook. For example, a user viewing any split query can instantly share it with his/her Facebook friends via a single click. This makes any entertaining split query potentially “viral” on the Internet. In some embodiments, user responses are recorded by the system in a database. This data can then be used to guide content to be served to the user in the future, as well as being applied by the system for statistical machine learning that guides targeting to some or all users.

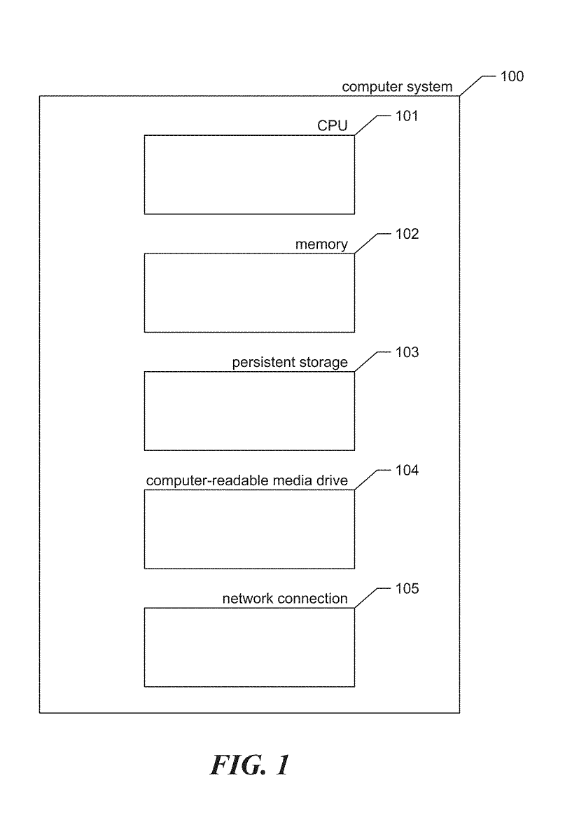

FIG. 1 is a block diagram illustrating some of the components that may be incorporated in at least some of the computer systems and other devices on which the disclosed technology operates and with which the disclosed technology interacts in some examples. In various examples, these computer systems and other devices 100 can include server computer systems, desktop computer systems, laptop computer systems, netbooks, tablets, mobile phones, personal digital assistants, televisions, cameras, automobile computers, electronic media players, and/or the like. In some embodiments, the facility may operate on one or more specific-purpose or specifically-programmed computing systems, such as a web server, and so on. In various examples, the computer systems and devices include one or more of each of the following: a central processing unit (“CPU”) 101 configured to execute computer programs; a computer memory 102 configured to store programs and data while they are being used, including a multithreaded program being tested, a debugger, the facility, an operating system including a kernel, and device drivers; a persistent storage device 103, such as a hard drive or flash drive configured to persistently store programs and data; a computer-readable storage media drive 104, such as a floppy, flash, CD-ROM, or DVD drive, configured to read programs and data stored on a computer-readable storage medium, such as a floppy disk, flash memory device, CD-ROM, or DVD; and a network connection 105 configured to connect the computer system to other computer systems to send and/or receive data, such as via the Internet, a Local Area Network (LAN), a Wide Area Network (WAN), a point-to-point dial-up connection, a cell phone network, or another network and its networking hardware in various examples including routers, switches, and various types of transmitters, receivers, or computer-readable transmission media. While computer systems configured as described above may be used to support the operation of the facility, those skilled in the art will readily appreciate that the facility may be implemented using devices of various types and configurations, and having various components. Elements of the facility may be described in the general context of computer-executable instructions, such as program modules, executed by one or more computers or other devices. Generally, program modules include routines, programs, objects, components, data structures, and/or the like configured to perform particular tasks or implement particular abstract data types and may be encrypted. Furthermore, the functionality of the program modules may be combined or distributed as desired in various examples. Moreover, display pages may be implemented in any of various ways, such as in C++ or as web pages in XML (Extensible Markup Language), HTML (HyperText Markup Language), JavaScript, AJAX (Asynchronous JavaScript and XML) techniques, or any other scripts or methods of creating displayable data, such as the Wireless Access Protocol (WAP). Typically, the functionality of the program modules may be combined or distributed as desired in various embodiments, including cloud-based implementations, web applications, mobile applications for mobile devices, and so on.

The following discussion provides a brief, general description of a suitable computing environment in which the invention can be implemented. Although not required, aspects of the invention are described in the general context of computer-executable instructions, such as routines executed by a general-purpose data processing device, e.g., a server computer, wireless device, or personal computer. Those skilled in the relevant art will appreciate that aspects of the invention can be practiced with other communications, data processing, or computer system configurations, including: Internet appliances, hand-held devices (including personal digital assistants (PDAs)), wearable computers (e.g., fitness-oriented wearable computing devices), all manner of cellular or mobile phones (including Voice over IP (VoIP) phones), dumb terminals, media players, gaming devices, multi-processor systems, microprocessor-based or programmable consumer electronics, set-top boxes, network PCs, mini-computers, mainframe computers, and the like. Indeed, the terms “computer,” “server,” “host,” “host system,” and the like are generally used interchangeably herein, and refer to any of the above devices and systems, as well as any data processor.

Aspects of the invention can be embodied in a special purpose computer or data processor that is specifically programmed, configured, or constructed to perform one or more of the computer-executable instructions explained in detail herein. While aspects of the invention, such as certain functions, are described as being performed exclusively on a single device, the invention can also be practiced in distributed computing environments where functions or modules are shared among disparate processing devices, which are linked through a communications network such as a Local Area Network (LAN), Wide Area Network (WAN), or the Internet. In a distributed computing environment, program modules may be located in both local and remote memory storage devices.

Aspects of the invention may be stored or distributed on tangible computer-readable media, including magnetically or optically readable computer discs, hard-wired or preprogrammed chips (e.g., EEPROM semiconductor chips), nanotechnology memory, biological memory, or other computer-readable storage media. Alternatively, computer-implemented instructions, data structures, screen displays, and other data under aspects of the invention may be distributed over the Internet or over other networks (including wireless networks), on a propagated signal on a propagation medium (e.g., electromagnetic wave(s), sound wave, etc.) over a period of time, or they may be provided on any analog or digital network (packet switched, circuit switched, or other scheme). Furthermore, the term computer-readable storage medium does not encompass signals (e.g., propagating signals) or transitory media.

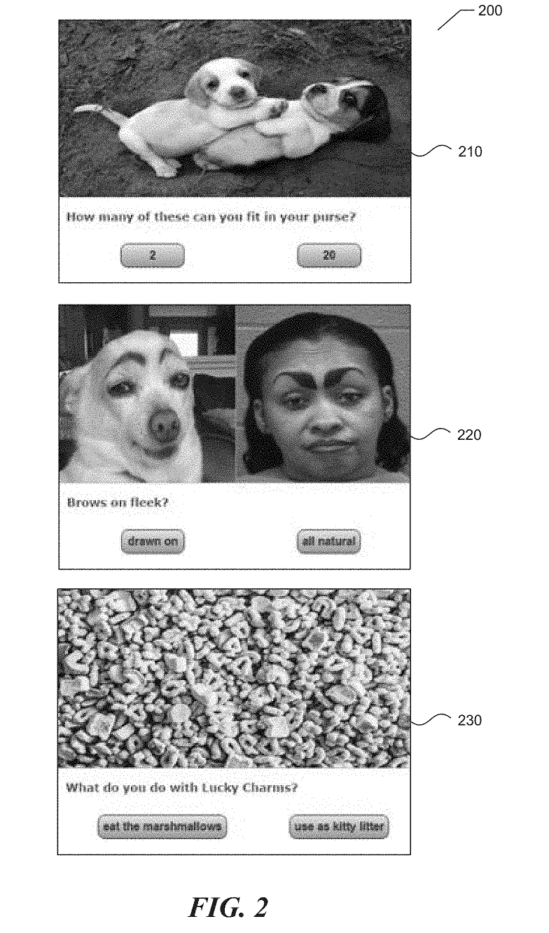

FIG. 2 is a page diagram illustrating several entertainment splits in accordance with some embodiments of the disclosed technology. In this example, page 200 includes splits 210, 220, and 230. Split 210 asks the user “How many of these [puppies] can you fit in your purse?” and presents the user with two options: 2 and 20. In some embodiments, when the user selects “2” or “20,” the system does not update any targeting variables, because split 220 is an entertainment Split as opposed to an advertising Split; however, the system may record the playback of the Split to the user, and the user's response; and it may track overall left-click vs right-click (and/or other selections) statistics as well as response speed to identify users who e.g. simply click one side repeatedly without contemplating their responses. Splits 220 and 230 are likewise entertainment Splits.

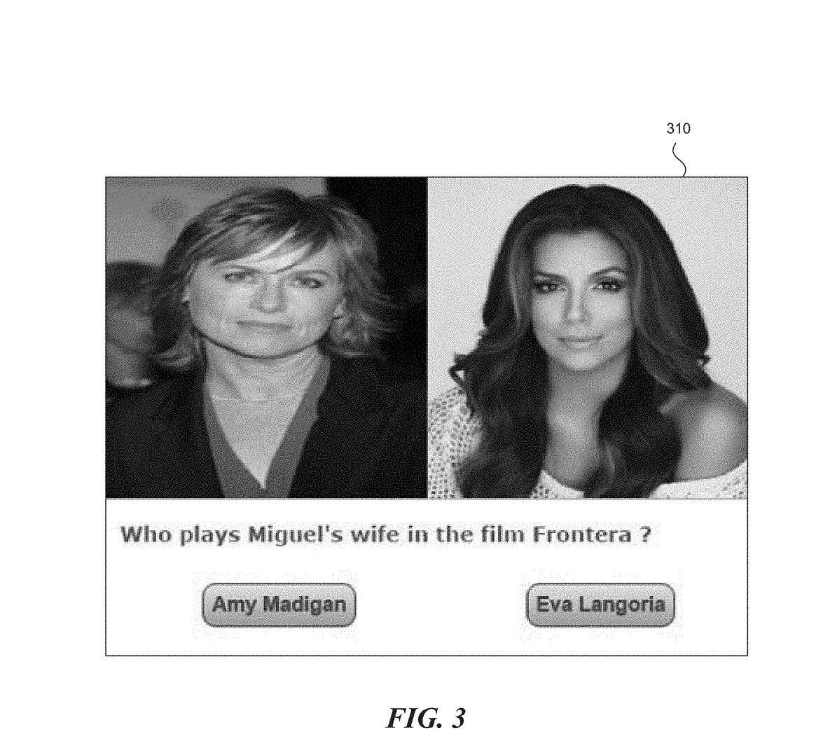

FIG. 3 is a page diagram illustrating a gamification split in accordance with some embodiments of the disclosed technology. Split 310 asks the user to answer a trivia question (i.e., “Who plays Miguel's wife in the film Frontera?”). The system can use the user's responses to this split to augment a user's profile. For example, if the user responds to the split correctly, the system may augment the user's profile to indicate that the user is, for example, a fan of (or knowledgeable about) certain subjects related to the split, such as the film Frontera, film generally, Eva Longoria, actresses, and so on. Similarly, if the user responds to the split incorrectly, the system may augment the user's profile to indicate that the user is, for example, not a fan of (or knowledgeable about) these or other topics. In some embodiments, the author of a split may designate certain subjects or variables as being associated with the split that the facility can use to augment a user's profile based on responses to the split. In some embodiments, there may be correct and incorrect answers, and choosing the correct answer may allow a user to win points or credits. In some cases, these points or credits may benefit the user (e.g., build toward a coupon) or may build toward a donation (e.g., to a charitable cause).

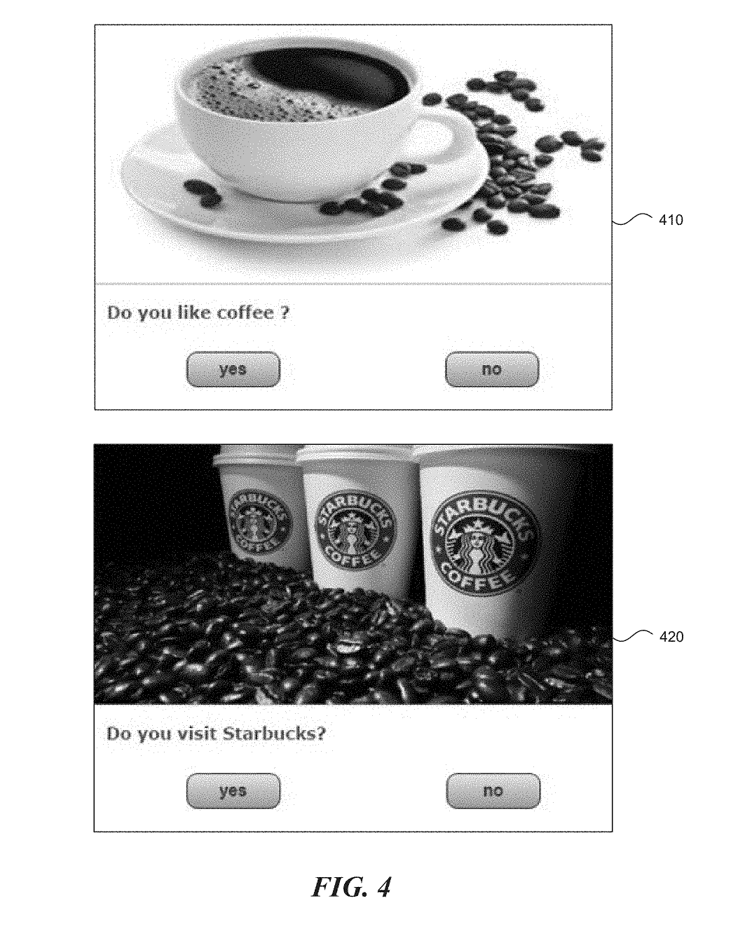

FIG. 4 is a page diagram illustrating advertising splits in accordance with some embodiments of the disclosed technology. In this example, page 400 includes splits 410 and 420. An advertising split (advertising query or advertisement split) presents one or more advertisements to a user and prompts the user to provide some feedback relative to the advertisement(s). In some embodiments, the facility interleaves advertising split queries into a split stream. The advertising splits or queries are made tolerable by publishing them into the same flow and as the same type of content as the entertainment splits or queries. Like the entertainment queries, the advertising queries appear as questions with associated images. The system can interleave the advertising queries sparsely into the entertainment polling flow so as to minimize the gap in the user's entertainment. The user controls the length of the advertisement's presentation because the advertisement query is dismissed as soon as the user responds to it. Furthermore, the system channels both entertainment-oriented queries and advertisement queries to the user based on internal scoring of the content's relevance and interest level for that user. In some embodiments, the sequence of split queries within a campaign that is presented to a given user can be dictated by the campaign configuration while the choice of campaign may be under the control of the system. The system may select the next campaign from which to present the next split to the user based on relevance and interest scoring (e.g., at a server), such as highest weighted-sum scoring, of the next split with respect to all available information about the user and split, and then serves the highest-scoring next split to the client for playback to the user. For example, if a user has exhibited an interest in a particular company or type of product (or has recently performed a search for a particular company or type of product), then the system may select a campaign related to that particular company or type of product. All of these factors contribute to making advertising tolerable and even enjoyable for users, including users on small form-factor devices, without occupying any additional screen real estate.

In some embodiments, a campaign (including campaigns used for purposes other than advertising) is a series of split queries played, for example, in order for a given user, but with other content interleaved. The “order” of the campaign is partially controlled by an advertiser's or other party's “custom variables” and “custom branching logic” over those variables. Each user (e.g., a user interacting with the splits of the campaign) can have a “position” with respect to each campaign. A user's “position” with respect to a campaign is the next split query of the campaign that is to be shown to that user. The order of the split queries may be determined by the system automatically or may be specified by a user (e.g., an administrator of the ad campaign). A campaign has a single “start” split query, which is the starting position for all users with respect to that campaign. A campaign, however, need not be strictly linear, as the campaign may include branch nodes, with different paths taken for different users based on accumulated data about each user. For example, a campaign for a music service may specify different branches, where a different branch is taken based on one or more of a user's indicated music preferences. Furthermore, a campaign may loop on itself, or on portions of itself, so it may or may not have (one or more) “end” splits, with no following splits. Once a user reaches an “end” split query of a campaign, he/she may or may not be looped back to the “start” split of the campaign. A user's positions in all campaigns may be tracked, for example, through a logged-in user session, via a cookie (web browser cookie or a unique id on a mobile device) for an anonymous user, and so on. In this manner, the user's path through a campaign is partially controlled by the associated “custom variables” and “custom branching logic” over those variables.

### Custom Targeting Variables

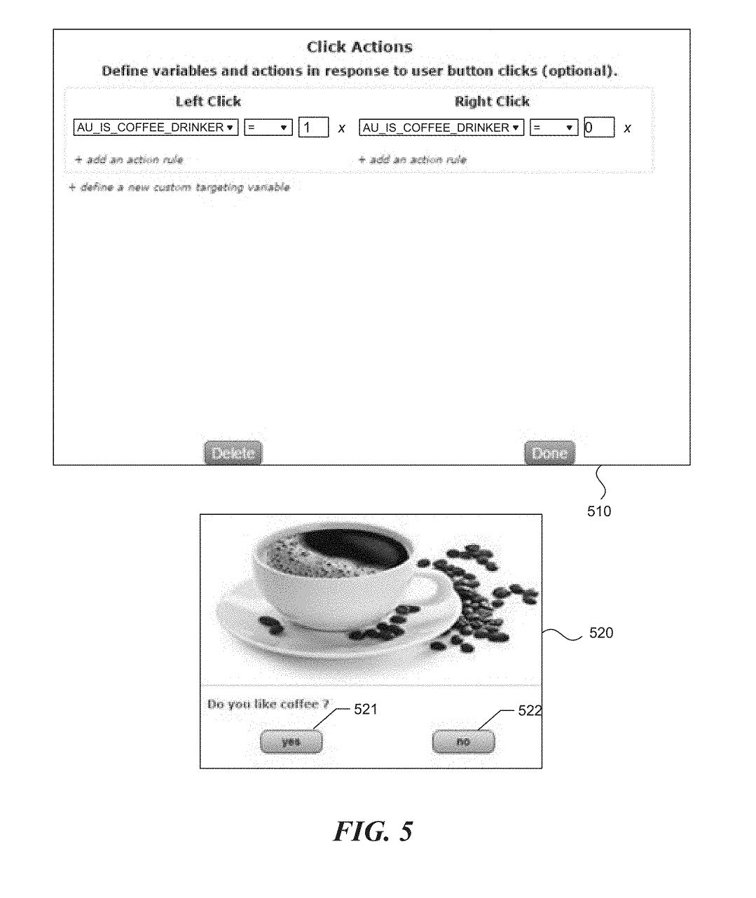

FIG. 5 is a page diagram illustrating a graphical user interface for authoring split queries in accordance with some embodiments of the disclosed technology. In some embodiments, the facility provides a graphical authoring interface, such as a web application, that allows a user to author or assemble text and images into a publishable “split” query. The user may define custom variables (with or without default values), the values of which may be modified by user responses to specific split queries. For example, an advertiser for a coffee chain may define a variable called “AU_IS_COFFEE_DRINKER,” with an initial default value of 0. That advertiser might also author a split query asking the user whether he/she likes coffee, with associated actions that a “yes” response assigns the “AU_IS_COFFEE_DRINKER” variable a value of 1 (interpreted as “true”) and a “no” response assigns the “AU_IS_COFFEE_DRINKER” variable a value of 0 (interpreted as “false”). Interface 510 allows a user to associate response values with a user's left-click or right-click on a specific split query. In this example, for the “Do you like coffee?” split query, the value of the “AU_IS_COFFEE_DRINKER” variable (a variable that indicates whether the user is a coffee drinker) is set to 1 (true) for the left button click (i.e., “Yes”), and 0 (false) for the right button click (i.e., “No”). Other authoring tools may generate individual splits or split campaigns based on user context; for example, a mobile app may integrate with a user's photos or social graph in order to assist in authoring or even suggest splits for entertainment or social polling or other purposes. In response to the user clicking “Done,” the system can create advertising split 520 with the appropriate values associated with each button 521 and 522 associated with the advertising split.

Continuing with the above example, the same advertiser may define another variable called “AU_IS_STARBUCKS_CUSTOMER,” with an initial default value of 0. And that advertiser might author a split query asking the user whether he/she is currently a customer of STARBUCKS, with associated actions that set the “AU_IS_STARBUCKS_CUSTOMER” variable to a value of either 1 or 0 (interpreted as “true” or “false”), based on the user's response. As another example, the same advertiser may define another variable called “AU_INFERRED_INCOME,” with an initial default value of 50000. Furthermore, the advertiser may author a split query asking the user a question of which the answer is indicative of yearly income. For example, the prompt may ask: “Do you own or rent your home?” An answer of “own my home” might trigger an advertiser-defined action that multiplies the value of the “AU_INFERRED_INCOME” variable by 1.5 (increasing it); whereas an answer of “rent my home” might trigger an advertiser-defined action that multiplies the value of the “AU_INFERRED_INCOME” variable by 0.6 (decreasing it). The combination of this and similar split queries, modifying the same user-associated variable, may result in a meaningful estimate of the user's annual income, which can be useful for ad targeting.

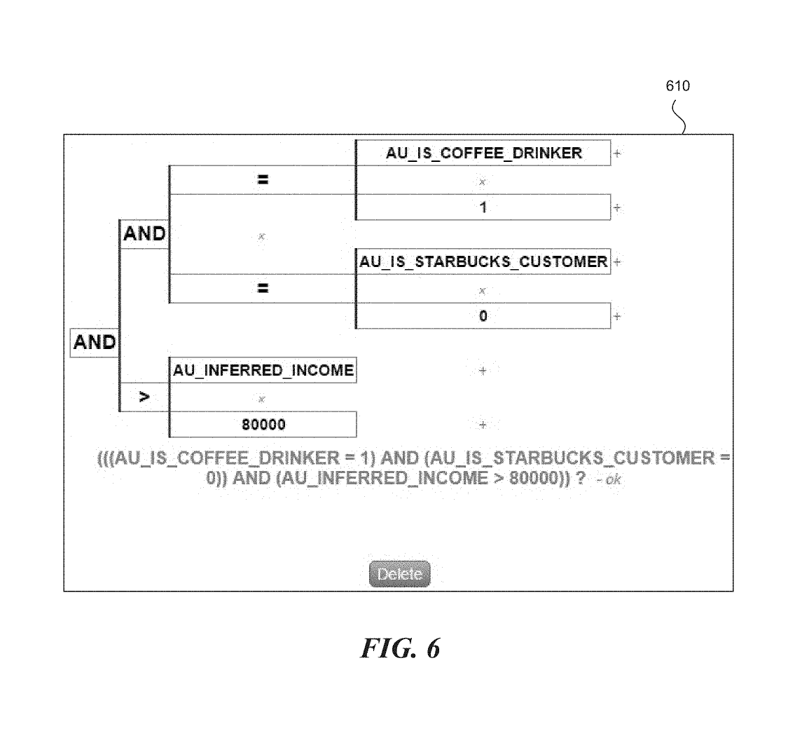

FIG. 6 is a page diagram illustrating a user interface 610 for authoring decision logic for a branch node in the action logic. In this example, a STARBUCKS representative (e.g., a marketing employee) has decided that he or she would like to market directly to users who are (1) coffee drinkers, (2) not current STARBUCKS customers, and (3) have an inferred income greater than $80,000. Thus, the combination of the variables in the above examples, associated with a given user, can be highly valuable for identifying customers relevant to the marketing strategy. These users may be prime targets for a coupon incentive, which may win over the user as a new STARBUCKS customer, without wasting coupons on established customers or unlikely new customers. In some embodiments, the targeting might be represented by the following boolean expression over the targeting variables: (AU_IS_COFFEE_DRINKER=1) AND (AU_IS_STARBUCKS_CUSTOMER=0) AND (AU_INFERRED_INCOME>80000). For example, the user might be targeted for a coupon if-and-only-if this composite expression evaluates to “true” with respect to that user. See “Flow Control of a Storyboarded Ad Campaign” below for how the targeting is implemented in the disclosed polling system. The above scenario exemplifies the type of advertiser-specific, highly nuanced targeting that the invention allows. As another example, an advertiser may be marketing sports cars. The advertiser may wish to target sports car enthusiasts in a particular location, with some given set of demographics and some set of advertiser-defined “psychographic” attitudes about cars, but who have NOT purchased a car in the past 5 years. Accordingly, the advertiser may establish appropriate splits and custom variables to collect the relevant information from users interacting with one or more split streams. Traditional advertising campaigns do not allow for this level of nuance and advertiser-specificity for ad targeting, because they are parameterized by a finite set of targeting variables that are pre-conceived by the traditional advertising system, rather than having the infinite flexibility of custom advertiser-defined targeting variables.

### Types of Custom Targeting Variables

In the above example, the “AU_” prefix in targeting variable names indicates an “Account-User” variable. This means that the variable has an instance per user and is shared by all advertising campaigns in the advertiser's account. So, in the above example, the value of the “AU_IS_COFFEE_DRINKER” variable set by [a user's response to] a split query in one campaign would be seen by all other campaigns in the same advertiser account.

A “Campaign-User” variable (e.g., with prefix “CU_”) is a targeting variable associated with a user and just a single advertising campaign. Such a variable has a separate instance for every user and for every ad campaign. An update of this type of variable in one campaign is not seen by split queries or branch nodes in another campaign.

A “Campaign” variable (e.g., with prefix “C_”) is a variable that is associated with a given campaign, but not any specific user. An advertiser might use this type of variable to track aggregate metrics about the campaign (e.g., the total number of users who responded in the affirmative to a given split query).

An “Account” variable (e.g., with prefix “A_”) is a variable that is associated with all campaigns in an advertising account, and not with any specific user. An advertiser might use this type of variable to track aggregate metrics across all owned campaigns (e.g., the total number of self-described coffee drinkers).

### System/Shared Variables

In addition to advertiser-defined custom targeting variables, defined above, the infrastructure also includes “System” and “Global-User” variables. These are variables defined by the system and shared across advertiser accounts and their campaigns. Their values are readable by the logic in branch nodes of advertiser campaigns, but may NOT be updatable by split queries in advertiser campaigns.

A “System” variable (e.g., with prefix “S_”) is a system-defined variable that is not associated with any specific user (though it may relate to the user's current session). An example is “S_DAY_OF_WEEK,” representing the current day of the week. Such a variable may be used by an advertiser to limit offers to specific times. Another example is “S_ZIP_CODE,” representing the approximate current location of the client device (user session). Such a variable can be used, for example, for geo-targeting.

A “Global-User” variable (e.g., with prefix “GU_”) is a system-defined variable that is associated with a specific user. It represents data that is collected by the system—not by an advertising campaign—about the user. An example is “GU_INFERRED_INCOME,” representing the inferred income of the user. Another example is “GU_INFERRED_MALENESS,” representing the degree of statistical confidence that the user is male. Such variables can be used for general demographic targeting. This user-specific data may be obtained by the system via direct querying of users, via statistical Data Science techniques applied to the user's polling response, or from other available data.

### Flow Control of a Storyboarded Ad Campaign

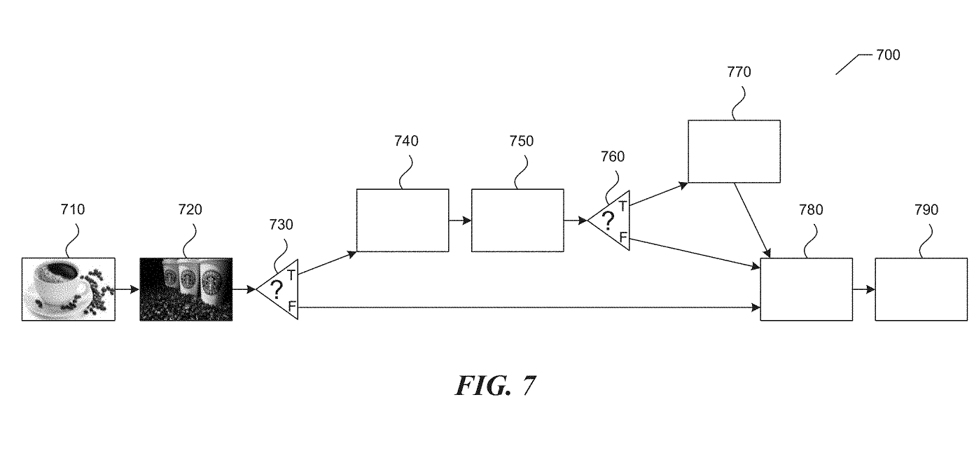

FIG. 7 is a block diagram illustrating a user interface for composing split queries and branch nodes into a split ad campaign in accordance with some embodiments of the disclosed technology. A split ad campaign consists of split queries and, in some cases, branch nodes. A split query is a user interface component shown to the user with a polling query (e.g., a binary polling query) and associated text and images. The split query may also have associated variables and variable-update actions. A branch node has no user interface component—it is a piece of custom logic that directs users in one of two directions based on the evaluation of a custom logical expression, which evaluates to a boolean (true or false) value. Each branch node (through its custom logic expression over targeting variables) directs the user experience to the proper next split query in a particular split ad campaign. In this example, split ad campaign 700 includes split queries 710, 720, 740, 750, and 770-790 and branch nodes 730 and 760. Split query 710 corresponds to advertising split 410 and asks whether the user likes coffee, while split query 720 corresponds to advertising split 420 and asks whether the user visits STARBUCKS. Split ad campaign 700 may include other split queries (not shown) used to gather other information from users. The system sets custom target variables based on user responses to these splits. Branch node 730 executes custom logic over those targeting variables. For example, if the user likes coffee, and is upper income, but is not already a STARBUCKS customer, then execution of the split ad campaign branches to node 740, else execution of the split ad campaign branches to node 780. Each of split queries 740, 750, and 770-790 represent other splits and are included to show the generality of branching and flow provided by split ad campaigns. Thus, the split ad campaign may execute differently for different users, based on their respective values for relevant targeting variables. The paths for targeted users may include specialized content, offers, coupons, etc.

In some embodiments, a user interface for designing individual splits is provided. In this user interface, the author can upload images and enter text (e.g., prompt text and button text) to configure the split query. The authoring service can also include a “Query Actions” component, allowing the author to define variables and to specify update actions on those variables associated with each button of each split query. Therefore, once launched, there are specified sets of update actions for each split query: one that executes each time a user clicks on one button and another that executes each time a user clicks on another button, and so on.

In some embodiments, each variable has an initial (default) value, which can be specified by the author. A variable update action can have various forms, such as:
AU_MY_VAR=<numeric value, or another variable>
   assigns the right-side value (constant value or another variable) to the left-side variable
AU_MY_VAR+=<numeric value, or another variable>
   adds the right-side value (constant value or another variable) to the left-side variable
AU_MY_VAR*=<numeric value, or another variable>
   multiplies the left-side variable by the right-side value (constant value or another variable)
AU_MY_VAR min <numeric value, or another variable>
   assigns the left-side variable the minimum of its current value and the right-side value
AU_MY_VAR max <numeric value, or another variable>
   assigns the left-side variable the maximum of its current value and the right-side value

Other basic operations, such as subtraction and division, can be implemented by applying the appropriate negative or reciprocal value on the right side of the update action. The authoring service also exposes a graphical branch-logic editor. This editor allows for the creation of a boolean expression, such as:
(AU_IS_COFFEE_DRINKER=1) AND (AU_IS_STARBUCKS_CUSTOMER=0) AND (AU_INFERRED_INCOME>80000)
   The authoring service also exposes a graphical flow-control programming interface. This interface displays an icon for each defined split query and branch node in the current ad campaign. The split and branch nodes can be chained by clicking and dragging them to connect them to each other. The links are directional, specifying a direction of flow for any given user. A split node has a single outgoing (“next”) link. A branch node has two outgoing links, one taken if its boolean logic expression evaluates as TRUE, and the other if its boolean logic expression evaluates as FALSE. The authoring service can enforce the well-formedness of the ad campaign (i.e., how well the ad campaign is formed). To be well-formed, each split query and branch-logic expression must be fully specified and the graph of split notes and branch nodes must be connected, with exactly one “start” node (the single node with no input link in the connected graph).

### Advertising Offers and Coupons

Flow control in a split ad campaign enables the system to direct targeted users to specialized content and possibly to present them with offers and/or coupons. The facility completes this advertiser workflow by integrating a creative tool for digital coupons. A digital coupon is an image uploaded by the advertiser with text specifying the offered product or service, monetary value, expiration date, and other related information. The coupon can be printed out or shown to the vendor's cashier on a mobile device. In order to ensure that redemption of an individual coupon is idempotent (defined herein as “single-use”), the techniques overlay a unique identifier or QR code on each digital coupon that is delivered to a user. The facility exposes a separate online service specifically for a vendor's cashier to redeem a coupon, by entering its unique code and verifying that it has not been redeemed before. Once defined, the coupon or offer is inserted as a node into the graphical representation of the split ad campaign in the aforementioned authoring service. Any user who reaches that node in the split ad campaign (possibly following a traversal of one or more branch nodes that successfully target that user) can be presented with an instance of the coupon or offer.

### User Contact Information

In some embodiments, in addition to coupons and offers, the disclosed technology allows an advertiser to prompt the user for contact information. Furthermore, in the portion of an ad campaign graph for targeted users, the advertiser may insert a “User Contact” node. Upon reaching this node in the ad campaign, the user is prompted to share contact information, such as phone number and email, with the advertiser for future contact by the advertiser's salespeople. The disclosed technology may store the user's contact information—either at the server or client-side in a cookie—so that the user does not have to enter it multiple times. However, the user must approve the sharing of his/her contact information with each vendor. The disclosed technology may also integrate the communication from the approved vendor to the user within the application itself, but allow the user to remain anonymous within the application.

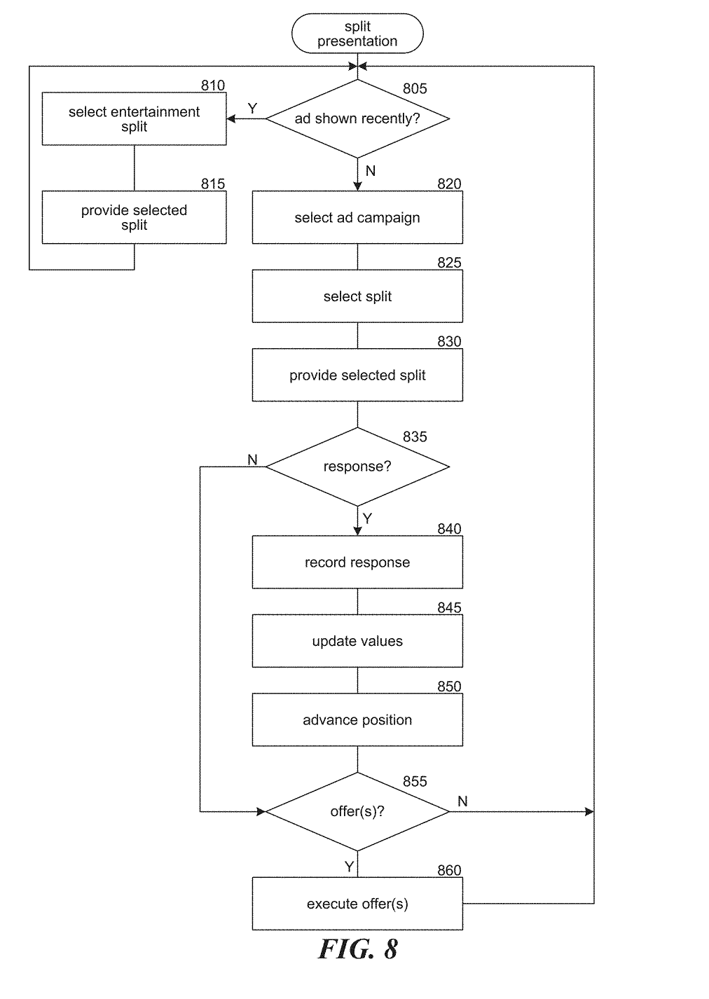

FIG. 8 is a flow diagram illustrating the processing of a split presentation component in accordance with some embodiments of the disclosed technology. The facility invokes the split presentation component in response to an opportunity to display a split to a user. In decision block 805, if an advertisement has been shown to a user recently, then the component continues at block 810, else the component continues at block 820. For example, the component may determine whether an advertisement has been presented during a previous period of time (e.g., one minute, one hour, one day, and so on). The period of time may be determined automatically by the facility based on, for example, the frequency with which advertisements have been presented to users, or may be predetermined by the author of the associated campaign. In block 810, the component selects an entertainment split for the user based on targeting and social criteria, such as demographic information about the user or demographic information about other users associated with the user (e.g., friends or connections on a social networking site). In some embodiments, the component selects an entertainment split based at least in part on a highest weighted-sum scoring of, for example: (1) an indicator of whether the user has seen the split before and, if seen before, the time since the user has seen the split, (2) recency of publication date of the split (favoring recently created content, i.e., Zeitgeist), (3) share rate of the split by the user's contacts (or other users associated with the user), (4) share rate of the split by other users, (5) share rate of semantically similar content by the user (where semantic similarity is measured by, for example, standard Natural Language Processing techniques), (6) share rate of semantically similar content by the user's contacts (where semantic similarity is measured by, for example, standard Natural Language Processing techniques), (7) share rate of semantically similar content by other users (where semantic similarity is measured by, for example, standard Natural Language Processing techniques), and so on. In block 815, the component provides the selected entertainment split for presentation to the user. In block 820, the component selects an advertising campaign for the user based on targeting and social criteria. In some cases, the targeting criteria may have a temporal component so that campaigns that have been presented to the user more recently are less likely to be selected than campaigns that have not been presented recently. In some embodiments, the component selects an advertising campaign based at least in part on a highest weighted-sum scoring of, for example: (1) an indicator of whether the user has seen his/her respective “next” split of the advertising campaign and, if seen before, the time since the user has seen the respective “next” split of the advertising campaign, (2) expected profit value of selecting the ad campaign, based on expectation of the user reaching commercial offer(s) within the ad campaign multiplied by the profit value(s) of those offer(s) as computed e.g. by an agreed fee ratio times the value of the offer, (3) share rate of any splits in the same ad campaign by the user, (4) share rate of any splits in the same ad campaign by the user's contacts (or other users associated with the user), (5) share rate of any splits in the same ad campaign by other users, (6) share rate of semantically similar content by the user (where semantic similarity is measured by, for example, standard Natural Language Processing techniques), (7) share rate of semantically similar content by the user's contacts (or other users associated with the user) (where semantic similarity is measured by, for example, standard Natural Language Processing techniques), and/or (8) share rate of semantically similar content by other users (where semantic similarity is measured by, for example, standard Natural Language Processing techniques), and so on. In some embodiments, the facility may charge advertisers based on the frequency with which their campaigns are presented. In block 825, the component selects a split from the ad campaign based on the user's current position within the campaign. In block 830, the component provides the selected split for presentation to the user. In decision block 835, if the user responds to the split, then the component continues at block 840, else the component proceeds to decision block 855. For example, the component may wait a predetermined amount of time (e.g., 5 seconds, 20 seconds, 1 minute, 5 minutes) for a response before proceeding to decision block 855. In block 840, the component records the user's response to the split. In block 845, the component updates any associated variable values for the user based on the response and the associated update actions associated with the split, such as interest information related to the split, demographic information associated with the split, and so on. In block 850, the component advances the user's position in the ad campaign to the next element in the campaign (e.g., split, coupon/offer, etc.) based on the campaign and associated branch logic (if any). In decision block 855, if there are any offers associated with the selected split, then the component continues at block 860, else the component loops back to decision block 805. In block 860, the component executes the associated offers and then loops back to decision block 805. In some embodiments, a means for presenting a split comprises one or more computers or processors configured to carry out an algorithm disclosed in FIG. 8 and this paragraph.

The following discussion provides a brief, general description of a suitable computing environment in which the invention can be implemented. Although not required, aspects of the invention are described in the general context of computer-executable instructions, such as routines executed by a general-purpose data processing device, e.g., a server computer, wireless device or personal computer. Those skilled in the relevant art will appreciate that aspects of the invention can be practiced with other communications, data processing, or computer system configurations, including: Internet appliances, hand-held devices (including personal digital assistants (PDAs)), wearable computers, all manner of cellular or mobile phones (including Voice over IP (VoIP) phones), dumb terminals, media players, gaming devices, multi-processor systems, microprocessor-based or programmable consumer electronics, set-top boxes, network PCs, mini-computers, mainframe computers, and the like. Indeed, the terms “computer,” “server,” “host,” “host system,” and the like are generally used interchangeably herein, and refer to any of the above devices and systems, as well as any data processor.

Aspects of the invention can be embodied in a special purpose computer or data processor that is specifically programmed, configured, or constructed to perform one or more of the computer-executable instructions explained in detail herein. While aspects of the invention, such as certain functions, are described as being performed exclusively on a single device, the invention can also be practiced in distributed computing environments where functions or modules are shared among disparate processing devices that are linked through a communications network, such as a Local Area Network (LAN), Wide Area Network (WAN), or the Internet. In a distributed computing environment, program modules may be located in both local and remote memory storage devices.

Aspects of the invention may be stored or distributed on tangible computer-readable media, including magnetically or optically readable computer discs, hard-wired or preprogrammed chips (e.g., EEPROM semiconductor chips), nanotechnology memory, biological memory, or other computer-readable storage media. Alternatively, computer-implemented instructions, data structures, screen displays, and other data under aspects of the invention may be distributed over the Internet or over other networks (including wireless networks), on a propagated signal on a propagation medium (e.g., electromagnetic wave(s), sound wave, etc.) over a period of time, or they may be provided on any analog or digital network (packet switched, circuit switched, or other scheme). Furthermore, the term computer-readable storage media does not encompass signals (e.g., propagating signals) or transitory media.

Unless the context clearly requires otherwise, throughout the description and the claims, the words “comprise,” “comprising,” and the like are to be construed in an inclusive sense, as opposed to an exclusive or exhaustive sense; that is to say, in the sense of “including, but not limited to.” As used herein, the terms “connected,” “coupled,” or any variant thereof means any connection or coupling, either direct or indirect, between two or more elements; the coupling or connection between the elements can be physical, logical, or a combination thereof. Additionally, the words “herein,” “above,” “below,” and words of similar import, when used in this application, refer to this application as a whole and not to any particular portions of this application. Where the context permits, words in the above Detailed Description using the singular or plural number may also include the plural or singular number, respectively. The word “or,” in reference to a list of two or more items, covers all of the following interpretations of the word: any of the items in the list, all of the items in the list, and any combination of the items in the list.

The above Detailed Description of examples of the invention is not intended to be exhaustive or to limit the invention to the precise form disclosed above. While specific examples of the invention are described above for illustrative purposes, various equivalent modifications are possible within the scope of the invention, as those skilled in the relevant art will recognize. For example, while processes or blocks are presented in a given order, alternative implementations may perform routines having steps or employ systems having blocks, in a different order, and some processes or blocks may be deleted, moved, added, subdivided, combined, and/or modified to provide alternative or subcombinations. Each of these processes or blocks may be implemented in a variety of different ways. Also, while processes or blocks are at times shown as being performed in series, these processes or blocks may instead be performed or implemented in parallel, or may be performed at different times. Further, any specific numbers noted herein are only examples; alternative implementations may employ differing values or ranges. Furthermore, although certain steps, functions, or functionalities may be described herein as being performed by or at a particular device, various steps, functions, functionalities, or portions thereof may be performed at other devices. For example, display previews may be generated at a server or client device.

The teachings of the invention provided herein can be applied to other systems, not necessarily the system described above. The elements and acts of the various examples described above can be combined to provide further implementations of the invention. Some alternative implementations of the invention may include not only additional elements to those implementations noted above, but also may include fewer elements.

Any patents and applications and other references noted above, including any that may be listed in accompanying filing papers, are incorporated herein by reference. Aspects of the invention can be modified, if necessary, to employ the systems, functions, and concepts of the various references described above to provide yet further implementations of the invention.

These and other changes can be made to the invention in light of the above Detailed Description. While the above description describes certain examples of the invention, and describes the best mode contemplated, no matter how detailed the above appears in text, the invention can be practiced in many ways. Details of the system may vary considerably in its specific implementation, while still being encompassed by the invention disclosed herein. As noted above, particular terminology used when describing certain features or aspects of the invention should not be taken to imply that the terminology is being redefined herein to be restricted to any specific characteristics, features, or aspects of the invention with which that terminology is associated. In general, the terms used in the following claims should not be construed to limit the invention to the specific examples disclosed in the specification, unless the above Detailed Description section explicitly defines such terms. Accordingly, the actual scope of the invention encompasses not only the disclosed examples, but also all equivalent ways of practicing or implementing the invention under the claims. In some cases, various steps in the algorithms discussed herein may be added, altered, or removed without departing from the disclosed subject matter. Those skilled in the art will appreciate that features described above may be altered in a variety of ways. For example, the order of the logic may be rearranged, sublogic may be performed in parallel, illustrated logic may be omitted, other logic may be included, etc.

To reduce the number of claims, certain aspects of the invention are presented below in certain claim forms, but the applicant contemplates the various aspects of the invention in any number of claim forms. For example, while only one aspect of the invention is recited as a means-plus-function claim under 35 U.S.C. §112(f), other aspects may likewise be embodied as a means-plus-function claim or in other forms, such as being embodied in a computer-readable medium. (Any claims intended to be treated under 35 U.S.C. §112(f) will begin with the words “means for,” but use of the term “for” in any other context is not intended to invoke treatment under 35 U.S.C. §112(f).) Accordingly, the applicant reserves the right to pursue additional claims after filing this application to pursue such additional claim forms, in either this application or in a continuing application.

I/We claim:

1. A method, performed by a computing system having a memory and a processor, the method comprising:
receiving, by the computing system, an indication of an opportunity to present a split to a user;
determining, by the computing system, that an advertising split has not been shown to the user during a previous predetermined amount of time; and
in response to determining that an advertising split has not been shown to the user during a previous predetermined amount of time,
selecting, by the computing system, a split advertising campaign for the user,
selecting, by the computing system, from the selected split advertising campaign, an advertising split for presentation to the user based at least in part on past interaction between the user and the split advertising campaign,
providing, by the computing system, the selected advertising split for presentation to the user,
receiving, by the computing system, from the user, a response to the selected advertising split, and
updating, by the computing system, values of custom variables for the user based at least in part on the received response to the selected advertising split.

2. The method of claim 1, wherein the indication of the opportunity to present the split to the user comprises an indication of the user and demographic information associated with the user.

3. The method of claim 1, further comprising:
in response to determining that an advertising has been shown to a second user during a previous predetermined amount of time,
selecting an entertainment split for the second user, and
providing the selected entertainment split for presentation to the second user.

4. The method of claim 1, further comprising:
in response to determining that an advertising has been shown to a second user during a previous predetermined amount of time,
selecting a trivia-oriented split for the second user, and
providing the selected trivia-oriented split for presentation to the second user.

5. The method of claim 4, further comprising:
providing a credit to the user based at least in part on a response to the selected trivia-oriented split.

6. The method of claim 1, wherein selecting the split advertising campaign for the user comprises:
retrieving a user profile for the user;
comparing a plurality of attributes from the retrieved user profile to attributes of a plurality of split advertising campaigns; and
for each of the plurality of split advertising campaigns,
determining the last time an advertising split from the split advertising campaign was presented to the user,
determining whether the user has seen a next split of the advertising campaign and, if the user has seen the next split of the advertising campaign, the time since the user has seen the next split of the advertising campaign,
determining an expected profit value of selecting the split advertising campaign, based at least in part on an expectation of the user reaching one or more commercial offers within the split advertising campaign,
determining a share rate of any advertising splits in the split advertising campaign by the user, and
determining a share rate of any advertising splits in the split advertising campaign by other users.

7. The method of claim 1, wherein selecting the advertising split for presentation to the user comprises:
retrieving an indication of an index into the selected split advertising campaign, wherein the index into the selected split advertising campaign is unique to the user and the selected split advertising campaign.

8. The method of claim 7, further comprising:
in response to receiving, from the user, the response to the selected advertising split, updating the index into the selected split advertising campaign.

9. The method of claim 1, wherein providing the selected advertising split for presentation to the user comprises providing the selected advertising split to a mobile device for presentation on the mobile device.

10. The method of claim 1, wherein providing the selected advertising split for presentation to the user comprises providing the selected advertising split to a wearable device for presentation on the wearable device.

11. The method of claim 1, further comprising:
providing the selected advertising split to one or more social networking sites on behalf of the user.

12. The method of claim 1, wherein the selected split advertising campaign comprises a plurality of splits and at least one branch node.

13. The method of claim 12, further comprising:
providing an interface for editing the selected split advertising campaign comprising the plurality of splits and the at least one branch node, the interface comprising:
for each of the plurality of splits,
a graphic corresponding to the split, and
a graphic corresponding to the at least one branch node.

14. The method of claim 1, further comprising:
receiving, from a second user, an indication of a plurality of custom variables associated with a second split advertising campaign;
generating, for each of the plurality of custom variables associated with the second split advertising campaign, an advertising split at least in part by:
receiving, from the second user, a query associated with the custom variable associated with the second split advertising campaign,
storing the query associated with the custom variable associated with the second split advertising campaign,
receiving, from the second user,
two or more potential responses to the received query, and
for each of the two or more potential responses to the received query, an action associated with the potential response, and
storing the received potential responses and the received actions associated with the potential responses; and
defining one or more paths through the second split advertising campaign based at least in part on the generated advertising splits.

15. A system, having a processor and a memory, the system comprising:
a component configured to receive, from a user, an indication of a plurality of custom variables associated with a split advertising campaign;
a split generation component configured to generate, for each of the plurality of custom variables associated with the split advertising campaign, an advertising split, the split generation component comprising:
a component configured to receive, from the user, a query associated with the custom variable associated with the split advertising campaign,
a component configured to store the query associated with the custom variable associated with the split advertising campaign,
a component configured to receive, from the user,
two or more potential responses to the received query, and
for each of the two or more potential responses to the received query, an action associated with the potential response,
a component configured to store the received potential responses and the received actions associated with the potential responses; and
a component configured to define one or more paths through the split advertising campaign based at least in part on the generated advertising splits,
wherein each of the components comprises computer-executable instructions stored in the memory for execution by the processor.

16. The system of claim 15, wherein the component configured to define one or more paths through the split advertising campaign based at least in part on the generated advertising splits comprises:
a component configured to define a branch node of the split advertising campaign associated with one or more of the generated advertising splits.

17. The system of claim 16, wherein the branch node is defined based at least in part on:
one of the custom variables, and
demographic information, geographic information, psychographic information, or a targeting variable.

18. The system of claim 16, wherein the branch node directs targeted users to advertising content.

19. The system of claim 18 wherein the advertising content comprises at least one of a coupon or commercial offer, wherein the coupon or commercial offer is digital, and is assigned a unique code so that the coupon or commercial offer is idem potent.

20. The system of claim 19, further comprising:
a component configured to present an online service for registering redemption of the coupon or commercial offer.

21. The system of claim 18, further comprising:
a component configured to prompt a targeted user to enter contact information for a vendor or allow for a sales contact.

22. The system of claim 15, further comprising:
a component configured to receive an indication of an opportunity to present an advertising split to a second user;
a component configured to determine that an advertising split has not been shown to the second user during a previous predetermined amount of time; and
a component configured to, in response to determining that an advertising split has not been shown to the second user during a previous predetermined amount of time,
select a split advertising campaign for the second user,
select, from the selected split advertising campaign, an advertising split for presentation to the second user based at least in part on past interaction between the second user and the split advertising campaign,
provide the selected advertising split for presentation to the second user,
receive, from the second user, a response to the selected advertising split, and
a component configured to update values of custom variables for the second user based at least in part on the received response to the selected advertising split.

23. A computer-readable storage medium storing instructions for performing a method, the method comprising:
receiving an indication of an opportunity to present a split to a user;
determining that an advertisement split has not been shown to the user during a previous predetermined amount of time; and
in response to determining that an advertisement split has not been shown to the user during a previous predetermined amount of time,
selecting a split advertisement campaign for the user,
selecting, from the selected split advertisement campaign, an advertisement split for presentation to the user based at least in part on past interaction between the user and the split advertisement campaign,
providing the selected advertisement split for presentation to the user,
receiving, from the user, a response to the selected advertisement split, and
updating values of custom variables for the user based at least in part on the received response to the selected advertisement split.
